(19) United States
(12) Patent Application Publication
(10) Pub. No.: US 2022/0034126 A1
(43) Pub. Date: Feb. 3, 2022

(54) LOCK ASSEMBLY

(71) Applicant: ASSA ABLOY NEW ZEALAND LIMITED, North Shore City (NZ)

(72) Inventor: Jianping ZHAO, Zhongshan City, Guangdong (CN)

(21) Appl. No.: 17/299,238

(22) PCT Filed: Nov. 28, 2019
(86) PCT No.: PCT/NZ2019/050155

§ 371 Date: Jun. 2, 2021

(30) Foreign Application Priority Data
Dec. 3, 2018 (NZ) 748911

(51) Int. Cl. E05B 59/00; E05B 63/08; E05B 55/00; E05B 63/00; E05B 63/14; E05C 9/04

(52) U.S. Cl. CPC E05B 59/00; E05B 63/08; E05B 55/00; E05B 2063/0082; E05B 63/14; E05C 9/041; E05B 63/0065

(57) ABSTRACT

A lock assembly, comprising: a drive hub configured to be rotated in a first angular direction; a latch having a latch engaged position; a lock having a locked position; a first locking member configured such that, when the lock is in the locked position, the first locking member retains the latch in the latch engaged position; and a second locking member configured such that, when the lock is in the locked position, the second locking member prevents the drive hub from rotating in the first angular direction.

### FIELD

The invention relates to a lock assembly.

### BACKGROUND

Doors often have a lock assembly which allows the door to be secured. This can prevent the door from being opened by an unauthorised person. Lock assemblies may include multiple points of locking for improved security.

A number of previous attempts have been made to provide suitable lock assemblies for doors. However, for some doors, existing lock arrangements may not be entirely suitable.

### SUMMARY

In a first example embodiment, there is provided a lock assembly, comprising: a drive hub configured to be rotated in a first angular direction; a latch having a latch engaged position; a lock having a locked position; a first locking member configured such that, when the lock is in the locked position, the first locking member retains the latch in the latch engaged position; and a second locking member configured such that, when the lock is in the locked position, the second locking member prevents the drive hub from rotating in the first angular direction.

In a second example embodiment, there is provided a lock assembly, comprising: a latch having a latch engaged position; a daylatch having a daylatch engaged position in which the latch is retained in the latch engaged position by the daylatch and a daylatch disengaged position in which the latch is not retained in the latch engaged position by the daylatch; and a lock configured to move between an unlocked position and a locked position; wherein after the lock enters the locked position, the daylatch is moved from the daylatch engaged position to the daylatch disengaged position.

In a third example embodiment, there is provided a lock assembly, comprising: a daylatch having a daylatch engaged position; and a drive hub configured to be rotated in a first angular direction or a second angular direction; wherein when the daylatch is in the daylatch engaged position, the drive hub is prevented from rotating in the first angular direction, but is not prevented from rotating in the second angular direction.

In a fourth example embodiment, there is provided a lock assembly, comprising: a lock having a locked position and an unlocked position; a deadbolt having a disengaged position and an engaged position; wherein when the lock is in the locked position, the deadbolt is able to be moved from the disengaged position to the engaged position.

### BRIEF DESCRIPTION OF DRAWINGS

The invention will be described by way of example with reference to the drawings, which show various preferred embodiments of the invention. However, these are provided for illustration only, and the invention is not limited to the particular details of the drawings and the corresponding description.

FIG. 1 shows an external view of a lock assembly according to an embodiment.

FIG. 2 shows a lock assembly in which a latch is in the engaged position, the lock actuator is in the unlocked position, and the deadbolt and shootbolts are in a disengaged position.

FIG. 3 shows the lock assembly of FIG. 2 in which the handle is operated in a securing direction.

FIG. 4 shows the lock assembly of FIG. 3 after the handle has been operated in the securing direction.

FIG. 5 shows the lock assembly of FIG. 4 while the handle is operated in a releasing direction.

FIG. 6 shows the lock assembly of FIG. 2 while the lock is operated in a securing direction.

FIG. 7 shows the lock assembly of FIG. 6 after the lock has been fully operated in the securing direction.

FIG. 8 shows the lock assembly of FIG. 7 while the handle is operated in the securing direction.

FIG. 9 shows the lock assembly of FIG. 8 after the handle has been fully operated in the securing direction.

FIG. 10 shows the lock assembly of FIG. 9 after the lock has been operated fully in the releasing direction.

FIG. 11 shows the lock assembly of FIG. 2 after the daylatch has been moved into an engaged position.

FIG. 12 shows the lock assembly of FIG. 11 while the lock is being operated in the securing direction.

FIG. 13 shows the top shootbolt actuator, bottom shootbolt actuator, and gear.

FIG. 14 shows the drive core and drive gear.

FIG. 15 shows the cover.

### DETAILED DESCRIPTION

In some embodiments, a lock assembly has four points of locking: typically a latch, a deadbolt, a top shootbolt, and a bottom shootbolt. These can be engaged, disengaged, and locked in place using one or more of three interfaces: typically a handle, a daylatch handle, and a lock.

For example, a handle turned in one direction may disengage the latch, the deadbolt, and the shootbolts. When released, the latch is re-engaged, but the deadbolt and shootbolts remain disengaged. When the handle is turned in the other direction, the deadbolt and shootbolts are then re-engaged.

When the daylatch handle is engaged, the latch cannot be disengaged by turning the handle. Instead, the daylatch handle must be turned first, or the lock locked and then unlocked.

When the lock actuator is engaged, the latch, deadbolt, and shootbolts cannot be disengaged by turning the handle. Instead, the lock must be unlocked first.

In this way, a lock assembly provides multiple modes of locking. This provides a lock assembly with a high degree of security and usability.

External View

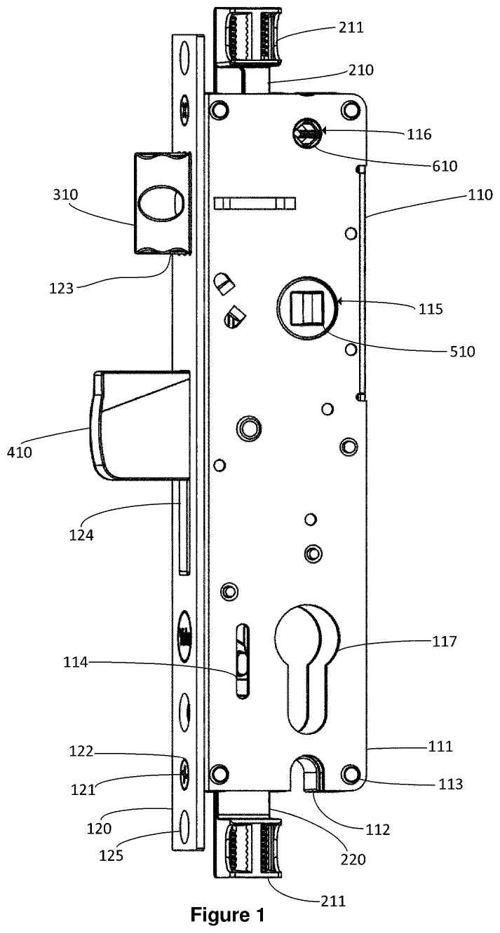

FIG. 1 shows an external view of a lock assembly according to one embodiment.

The lock assembly has a latch 310 which can move between engaged and disengaged positions. In the engaged position, the latch 310 extends outside the housing 110 of the lock assembly. When the lock assembly is installed in a door, the latch 310 can extend into a recess in the jamb of a door frame, optionally through a hole in a strike plate on the jamb. This impedes the door from being opened, and so holds the door relative to the door frame. In a disengaged position, the latch 310 is withdrawn substantially within the housing 110 of the lock assembly. When the lock assembly is installed in a door, the latch 310 in the disengaged position does not engage the jamb, and so does not impede the movement of the door relative to the door frame.

The latch 310 provides a first point of locking.

The lock assembly has a deadbolt 410 which can move between engaged and disengaged positions. In the engaged position, the deadbolt 410 extends outside the housing 110 of the lock assembly. When the lock assembly is installed in a door, the deadbolt 410 can extend into a recess in the jamb of a door frame or in a recess in the strike plate. This may be a different recess from that for the latch 310. This impedes the door from being opened, and so holds the door relative to the door frame. In a disengaged position, the deadbolt 410 is withdrawn substantially within the housing 110 of the lock assembly. When the lock assembly is installed in a door, the deadbolt 410 in the disengaged position does not engage the jamb, and so does not impede the movement of the door relative to the door frame.

The deadbolt 410 provides a second point of locking.

The deadbolt 410 may be engaged independently of the latch 310, such that one is in its engaged position while the other is in its disengaged position.

The lock assembly has a top shootbolt and a bottom shootbolt. These are connected respectively to a top shootbolt actuator 210 and bottom shootbolt actuator 220 via bolt receivers 211, 221. For example, the shootbolts may be screwed into the bolt receivers 211, 221. The shootbolts (and consequently the shootbolt actuators 210 and 220) each have respective engaged and disengaged positions. In the engaged position, the shootbolt is extended relative to the housing 110 of the lock assembly. When the lock assembly is installed in a door, the shootbolt extends into a recess in the door frame. The top shootbolt extends into a recess in the lintel and the bottom shootbolt extends into a recess in the sill. These impede the door from being swung, and so hold the door relative to the door frame. In the disengaged position, the shootbolts are withdrawn relative to the housing 110 of the lock assembly. This may result in the top shootbolt actuator 210 and bottom shootbolt actuator 220 being entirely within the housing 110 of the lock assembly. When the lock assembly is installed in a door, the shootbolts in the disengaged position do not engage the door frame, and so do not impede the movement of the door relative to the door frame.

The shootbolts provide third and fourth points of locking.

The shootbolts may be engaged and disengaged concurrently with the deadbolt 410, but independently of the latch 310.

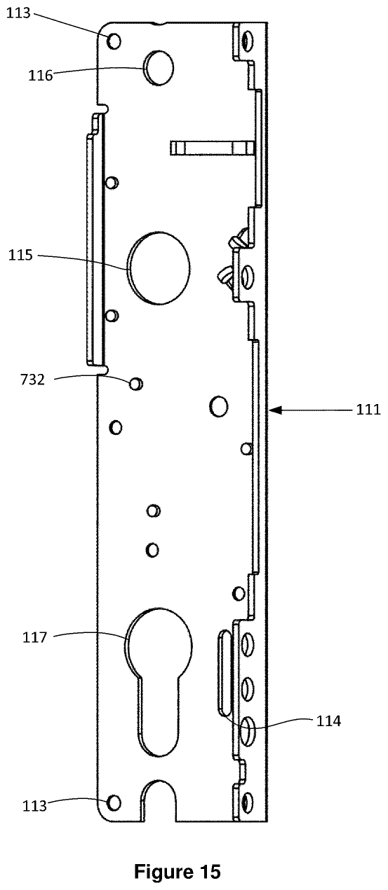

The illustrated lock assembly is a mortice lock assembly for installation in the mortice of a door. The housing 110 has a cover 111 and a base 112 which are fastened together, for example by screws through aperture 113. The cover 111 is shown in FIG. 15.

A drive hub aperture 115 is provided in the cover 111 and the base 112 for access to a drive hub 510. A daylatch hub aperture 116 is provided in the cover 11 and the base 112 for access to a daylatch hub 610. A lock aperture 117 is provided in the cover 111 and the base 112 to allow a lock 710 to pass through and be accessed from either side.

The housing may have a face plate 120 fixed to one side, for example by screws 121 via screw holes 122. The face plate 120 has a latch aperture 123 to allow the latch 310 to pass through, and a deadbolt aperture 124 to allow the deadbolt 410 to pass through. The deadbolt aperture 124 may be sized so as to allow the deadbolt 410 to pivot outwards. Screw holes 125 may be provided on the face plate 120 to allow the face plate to be fixed at either end of a mortice of a door via screws.

Internal View

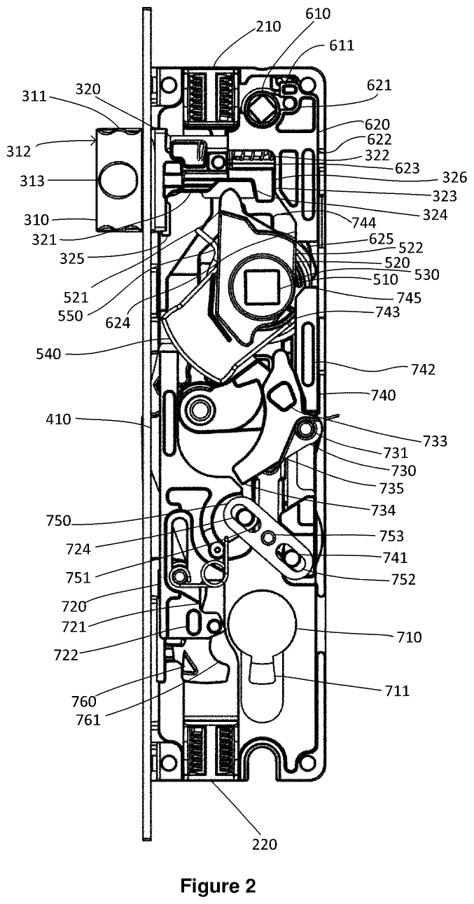

FIGS. 2 to 12 show sectional views of an embodiment of the lock assembly in different states, as viewed underneath the cover 111. The handle and daylatch handle are omitted for clarity.

Latch

The latch 310 is used to retain a door relative to a door frame. The latch 310 can have an angled face 311 so that as the door is closed, the latch 310 is urged inwards instead of striking the door frame. The opposing face 312 may be flat so that it hits against the recess in the door jamb, preventing the door from being opened without the latch 310 being disengaged. The latch 310 moves along a linear path between an engaged position in which the latch 310 extends out of the housing 110 and a disengaged position in which the latch 310 is mostly or wholly withdrawn into the housing 110.

The latch 310 is connected to a latch chassis 320. This can occur via a screw or other fastener passing through a screw hole 313 in the latch 310. This can engage a screw hole 321 in the latch chassis to fix the latch 310 and the latch chassis 320 together.

The latch chassis 320 sits within the housing 110, and moves along a linear path between an engaged position in which the latch chassis 320 is relatively close to the latch aperture 123 and a disengaged position in which the latch chassis 320 is relatively far from the latch aperture 123. Even in the engaged position, the latch chassis 320 typically does not extend outside of the housing 110. Due to the connection between the latch 310 and the latch chassis 320, movement between the engaged and disengaged positions of one of the latch 310 and the latch chassis 320 can cause concurrent movement between the engaged and disengaged positions of the other.

A separate latch 310 and latch chassis 320 allows the latch 310 to be rotated such that the angled face 311 is oriented towards a closing direction of the door. This provides for a non-handed lock assembly. However, in some cases, the latch 310 and the latch chassis 320 are integrally formed.

A spring 322 urges the latch chassis 320 (and consequently the latch 310) towards the engaged position. To achieve this, the spring 322 may push against an inner wall of the housing 110 opposite the latch aperture 123.

The latch chassis 320 has a shoulder 323 with a face 324 substantially orthogonal to the direction of force exerted by the spring 322. Force applied to the face of 324 of the shoulder 323 may be used to resist the urging of the spring 322 and thus move the latch chassis 320 (and consequently the latch 310) towards the disengaged position. When the force is removed, the latch chassis 320 and latch 310 are typically urged back to the engaged position by the spring 322.

The latch chassis 320 has an abutment 325 opposing the face 324 of the shoulder 323. A force applied to the abutment 325 may impede the latch chassis 320 and thus the latch 310 being moved into the disengaged position.

An end 326 of the latch chassis may be flat, so as to present a further abutment face.

Deadbolt

The deadbolt 410 is used to retain a door relative to a door frame, and may be relatively thick and sturdy so as to resist breaking, warping, or other damage even under force. The deadbolt may be made of a relatively strong metal such as steel.

The deadbolt 410 may be bevelled at one edge 411. As the deadbolt 410 is engaged, this bevelling can allow the deadbolt to better align within a recess in the door jamb, and therefore reduce the risk of damage that may occur due to a misaligned deadbolt 410. In addition, when the bevelled edge 411 comes into contact with the recess, the door is pulled into the frame and against seals in the frame. This provides for improved sealing in the door,

The deadbolt 410 is fixed to the lock assembly via a pivot point 420. For example, the pivot point 420 may be a screw, rivet, or post. The deadbolt 410 pivots about pivot point 420 between an engaged position in which the deadbolt 410 extends at least partly outside of the housing 110 and a disengaged position in which the deadbolt 410 is mostly or wholly within the housing 110. The engaged position may be delimited by the deadbolt 410 pushing against a top of the deadbolt aperture 124.

Teeth 412 are provided on one side of the deadbolt. Force applied to the teeth 412 may cause the deadbolt 410 to pivot about pivot point 420 between engaged and disengaged positions.

A notch 413 in the deadbolt 410 provides a further bearing surface 414. Force applied to the bearing surface 414 can cause the deadbolt 410 to move towards the engaged position or to retain the deadbolt 410 in the engaged position.

A deadbolt lock 730 is provided which pivots about a pivot point 731 between locked and unlocked positions. The extent of pivoting may be limited by a pin 732 moving in a channel 733. The deadbolt lock 730 has an extension 734 which can fit in the notch 413 and push against the bearing surface 414 of the deadbolt 410.

When the deadbolt lock 730 is in the locked position, the extension 734 abuts the bearing surface 414. This retains the deadbolt 410 in the engaged position. An attempt to move the deadbolt 410 towards the disengaged position (for example, by use of the handle or by pressure on the deadbolt 410 directly) would be resisted by the extension 734.

When the deadbolt lock 730 is in the unlocked position, the extension 734 is not aligned with the notch 413, and therefore does not impede movement of the deadbolt 410.

A spring 735 may be provided to bias the deadbolt lock 730 towards the locked position. The deadbolt 410 in its disengaged position may hold the deadbolt lock 730 in its unlocked position.

Shootbolts

The top shootbolt actuator 210 comprises a bolt receiver 211 at one end which can retain a shootbolt. The bolt receiver 211 may be threaded to engaged with a screw thread on the shootbolt. A rack 212 is located at the other end of the top shootbolt actuator 210. The rack 212 has a number of teeth 213. Force applied to a side of the teeth 213 can cause the top shootbolt actuator 210 (and thus a retained shootbolt) to move linearly between an engaged position and a disengaged position. In the engaged position, the top shootbolt actuator 210 extends partly out of the top of the housing 110. This causes the retained shootbolt to enter a recess in a lintel of a door frame, and impedes the door from opening. In the disengaged position, the top shootbolt actuator 210 is withdrawn largely or entirely within the housing 110. This causes the retained shootbolt to be withdrawn from the recess in the lintel.

A block 214 extends from the top shootbolt actuator 210. When the top shootbolt actuator 210 is in the engaged position, the block 214 is positioned to abut the abutment 325 of the latch chassis 320. Thus the top shootbolt actuator 210 being in the engaged position can prevent the latch chassis 320 from moving into the disengaged position.

The bottom shootbolt actuator 220 comprises a bolt receiver 221 at one end which can retain a shootbolt. The bolt receiver 221 may be threaded to engaged with a screw thread on a shootbolt. A rack 222 is located at the other end of the bottom shootbolt actuator 220. The rack 222 has a number of teeth 223. Force applied to a side of the teeth 223 can cause the bottom shootbolt actuator 220 (and thus a retained shootbolt) to move linearly between an engaged position and a disengaged position. In the engaged position, the bottom shootbolt actuator 220 extends partly out of the bottom of the housing 110. This causes the retained shootbolt to enter a recess in a sill of a door frame, and impedes the door from opening. In the disengaged position, the bottom shootbolt actuator 220 is withdrawn largely or entirely within the housing 110. This causes the retained shootbolt to be withdrawn from the recess in the sill.

A gear 230 is coaxial with the deadbolt 410, and pivots about pivot point 420. The teeth of the gear 230 mesh with the rack 212 of the top shootbolt actuator 210 and the rack 222 of the bottom shootbolt actuator 220.

The gear 230 can be coupled to the deadbolt 410 such that one of the deadbolt 410 and the gear 230 pivoting about pivot point 420 causes the other to pivot. In this way, the deadbolt, the top shootbolt actuator 210, and the bottom shootbolt actuator 220 all move between their respective engaged and disengaged positions concurrently.

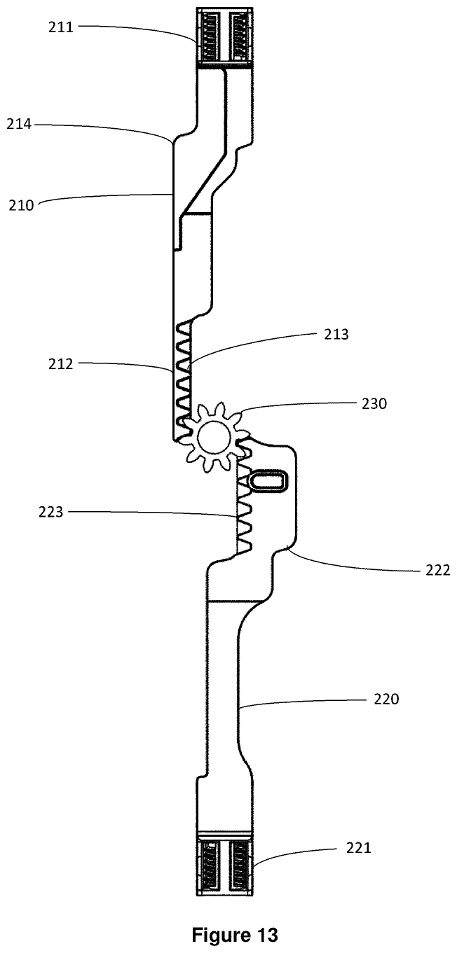

The top shootbolt actuator 210, bottom shootbolt actuator 220, and gear 230 are shown in more detail in FIG. 13.

Drive Hub

A drive hub 510 is accessible from either side of the housing 110 through a drive hub aperture 115. The drive hub 510 is polygonal (such as square shaped), and receives a similar shaped spindle of a handle. As the handle is operated, the spindle causes the drive hub 510 to rotate. The extent of rotation of the drive hub 510 may be limited, such as to about 40 degrees in either axial direction from neutral.

The handle can typically be operated in two directions. In a securing direction (a first angular direction such as anti-clockwise), this can cause the deadbolt 410 and shootbolts to be engaged. In a releasing direction (a second angular direction such as clockwise), this can cause the deadbolt 410, shootbolts, and latch 310 to be disengaged.

The drive hub 510 has a coaxial drive cam 520 and drive core 530 which rotate in concert with the handle. A spring 550 is provided to urge the drive hub 510 to a neutral position. Thus when the handle is operated by a user, the drive hub 510 can rotate in either axial direction up until a maximum extent of rotation. This is because the user is resisting the urging of the spring 550. When the user releases the handle, the drive hub 510 may revert back to neutral.

The drive cam 520 has a finger 521 for interacting with the face 324 of the shoulder 323 of the latch chassis 320. When the drive cam 520 is rotated in a first direction (such as clockwise), the finger 521 pushes against the face 324. This causes the latch chassis 320 to move towards the disengaged position. Thus the maximum extent of rotation of the drive hub 510 in the releasing direction may be aligned with the amount of lateral movement of the latch chassis 320 to move fully into the disengaged position.

When the drive cam 520 reverts back to the neutral position (due to the handle being released), the finger 521 no longer contacts the face 324 and therefore no longer resists the spring 322. Thus the latch chassis 320 and latch 310 may revert back to the engaged position when the handle is released.

The drive cam 520 has an edge 522 which is orthogonal to the direction of rotation. In use, if another element abuts the edge 522, then can impede the drive cam 520 from rotating in at least one direction.

The drive core 530 interacts with a coaxial drive gear 540. For example, teeth 531 of the drive core 530 may push against bearing surfaces 541 of the drive gear 540.

This may be a lost motion arrangement, so that some amount of rotation of the drive core 530 may not translate to rotation of the drive gear 540. This may allow the drive core 530 to revert to a neutral position (for example, due to the handle being released) without moving the drive gear 540.

The drive gear 540 has teeth 542 at one end which mesh with the teeth 412 of the deadbolt. As the drive gear 540 rotates, the deadbolt 410 also rotates due to this meshing. In this way, operation of the handle can move the deadbolt between engaged and disengaged positions. Moreover, due to gear 230, operation of the handle can move the shootbolts between engaged and disengaged positions.

In some cases, the teeth 412 of the deadbolt 410 and the teeth 542 of the drive gear 540 may be omitted. Instead, the deadbolt 410 and the drive gear 540 may be linked by a pin, such that rotation of the drive gear 540 is translated to rotation of the deadbolt 410 via the pin.

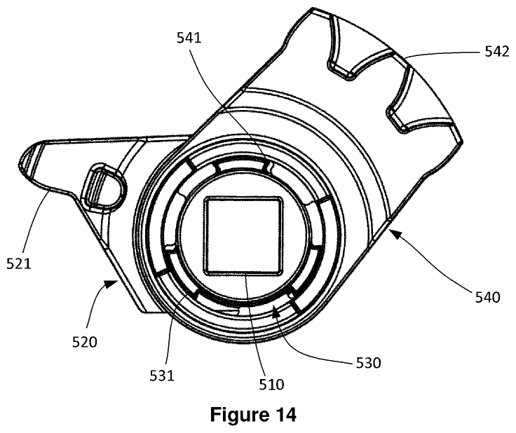

The drive core 530 and drive gear 540 are shown in more detail in FIG. 14.

Daylatch

The lock assembly has a daylatch to prevent the latch from being disengaged until the daylatch is disengaged.

A daylatch hub 610 is accessible from one side of the housing 110 through a daylatch hub aperture 116. The daylatch hub 610 is polygonal (such as square shaped), and receives a similar shaped spindle of a daylatch handle or snib. The daylatch hub 610 has a cam 611 which fits into a recess 621 of a daylatch plate 620.

The daylatch plate 620 has a daylatch block 622 at one end. The daylatch block 622 has a latch abutment face 623 which can abut the end 326 of the latch chassis 320. The daylatch plate 620 moves linearly between a locked and an unlocked position. In a locked position, the latch abutment face 623 of the daylatch block 622 is located in line with the end 326 of the latch chassis 320. If the latch chassis 320 is attempted to be moved into the disengaged position, the end 326 will abut the latch abutment face 623 of the daylatch block 622. This impedes movement of the latch chassis 320 into the disengaged position, and so locks the latch chassis 320 (and thus the latch 310) in the engaged position. In an unlocked position, the latch abutment face 623 of the daylatch block 622 is out of alignment with the end 326 of the latch chassis 320, and therefore does not impede movement of the latch chassis 320 into the disengaged position.

When the daylatch handle is operated, the interaction of the cam 611 and the recess 621 causes the daylatch plate 620 to move between the locked and unlocked positions. The maximum extent of rotation of the daylatch handle may be about 90 degrees. This can be limited by the daylatch plate 620 pushing against an inner face of the housing 110 or a portion of the latch chassis 320.

The daylatch block 622 has a drive hub abutment face 624 which can abut a part of the edge 522 of the drive cam 520. In a locked position, the drive hub abutment face 624 of the daylatch block 622 is located in line with at least part of the edge 522 of the drive cam 520. If the handle is attempted to be operated (to cause the drive hub 510 to rotate), the edge 522 will push against the drive hub abutment face 624. This impedes rotation of the drive cam 520, and thus the drive hub 510, the drive core 530, and the spindle of the handle in the releasing direction. In an unlocked position, the drive hub abutment face 624 of the daylatch block 622 is out of alignment with the edge 522, and therefore does not impede rotation of the drive cam 520, drive core 530, and spindle of the handle.

In this way, the daylatch block 622 can be used to lock the handle in place. When the daylatch is engaged (that is, when the daylatch handle has been rotated so as to locate the daylatch plate 620 into the locked position), the handle is not able to be operated in the releasing direction, and so the door cannot be opened. The daylatch therefore provides two points of locking: one in which the latch chassis 320 is locked in the engaged position by the latch abutment face 623, and one in which the handle is locked in place by the drive hub abutment face 624. Even if one of these points of locking were compromised, the other would still retain the latch 310 in place until the daylatch is disengaged.

Lock

The lock assembly further has a lock 710. The lock 710 may be a cylinder lock in which a cylinder rotated relative to a housing of the lock. A cam 711 can rotate in concert with the cylinder. In some cases, a suitable key is required to be inserted into the lock 710 and turned to actuate the cylinder and the cam 711. The key may only be insertable or removable when the cylinder is at a predetermined location. Improper keys may cause pins to be misaligned, inhibited the rotation of the cylinder and the cam 711. In other cases, a thumb turn, snib, or other non-key actuator may be used.

The lock 710 can be locked and unlocked by being operated in a securing direction and a releasing direction respectively. This means that the cam 711 is rotated in the securing direction and releasing direction relative to the housing of the lock 710.

The cam 711 engages with a cam recess 721 of a lock actuator 720. The lock actuator 720 moves linearly between a locked position and an unlocked position along a path as defined by pins 722 moving in channels. One pin 722 may move in a channel 114 of the cover 111 which can provide an indicator of the state of the lock actuator 720.

When the lock actuator 720 is in the unlocked position, and when the cam 711 rotates in a first, securing direction (such as anti-clockwise), the cam 711 enters the cam recess 721 after around 225 degrees of rotation. Further rotation of the cam 711 causes the cam 711 to push against a side of the cam recess 721. This forces the lock actuator 720 towards the locked position. After around 300 degrees of rotation, the lock actuator 720 reaches the locked position. Further rotation of the cam 711 causes the cam to exit the cam recess 721. The cam 711 can then complete a full rotation to return to its starting position.

When the lock actuator 720 is in the locked position, and when the cam 711 rotates in a second, releasing direction (such as clockwise), the cam 711 enters the cam recess 721 after around 60 degrees of rotation. Further rotation of the cam 711 causes the cam 711 to push against a side of the cam recess 721. This forces the lock actuator towards the unlocked position. After around 135 degrees of rotation, the lock actuator 720 reaches the unlocked position. Further rotation of the cam 711 causes the cam 711 to exit the cam recess 721. The cam 711 can then complete a full rotation to return to its starting position.

The lock 710 may be considered to be in a locked mode when the lock actuator 720 is in the locked position, and an unlocked mode when the lock actuator 720 is in the unlocked position. This may be the case even though the lock 710 and the cam 711 may be in the same physical configuration after the lock actuator 720 has been moved into the locked or unlocked positions. Thus the locked and unlocked mode of the lock 710 may be defined by the locked and unlocked position of the lock actuator 720.

When the lock actuator 720 is in the unlocked position, if the cam 711 rotates in the securing direction, the cam 711 abuts the lock actuator 720. When the lock actuator 720 is in the locked position, if the cam 711 rotates in the releasing direction, the cam 711 also abuts the lock actuator 720. This restrains the direction of rotation of the cam 711 based on the locked or unlocked state of the lock actuator 720.

A locator arm 760 may be provided to provide feedback to the user as the cam 711 is rotated. One or more detents 761 provide a tactile and/or audible feedback when the cam 711 reaches certain points of rotation. These may correspond to when the lock actuator 720 reaches the locked and unlocked positions respectively. A spring may be provided to bias the locator arm 760 against the cam 711 during rotation away from the starting position in at least one direction. This helps to locate the cam 711 in a suitable position for a key to be removed.

The lock actuator 720 is linked to a locking arm 740 by a linkage 750. A linkage pin 724 of the lock actuator 720 is received in a first channel 751 of the linkage 750. A linkage pin 741 of the locking arm 740 is received in a second channel 752 of the linkage 750. The linkage 750 pivots about a pivot point 753. The linkage 750 ensures that the linkage pin 724 of the lock actuator 720 and the linkage pin 741 of the locking arm 740 are maintained at a constant distance from one another. Thus as one of the lock actuator 720 and the locking arm 740 move in one linear direction, the linkage 750 causes the other to move in an opposing linear direction.

The locking arm 740 therefore moves along a linear path between a locked position corresponding to the locked position of the lock actuator 720, and an unlocked position corresponding to the unlocked position of the lock actuator 720. The linear path may be further ensured by a pin moving in linear channel 742.

When the locking arm 740 is in the locked position, a drive hub block 743 is located in line with at least part of the edge 522 of the drive cam 520. If the handle is attempted to be operated in a releasing direction to cause the drive hub 510 to rotate, the edge 522 will push against the drive hub block 743. This impedes rotation of the drive cam 520, and thus the drive hub 510, the drive core 530, and the spindle of the handle. If the handle is attempted to be operated in a securing direction, the edge 522 will move away from the drive hub block 743. Thus the handle can still move in a securing direction even if the locking arm 740 is in a locked position.

In addition, a latch block 744 is located in line with at least part of the end 326 of the latch chassis 320. If the latch chassis 320 is attempted to be moved towards its disengaged position, the end 326 of the latch chassis 320 abuts the latch block 744. This impedes movement of the latch chassis 320 (and thus the latch 310) towards its disengaged position when the locking arm 740 is in its locked position.

In an unlocked position, the drive hub block 743 of the locking arm 740 is out of alignment with the edge 522, and therefore does not impede rotation of the drive cam 520, drive core 530, and spindle of the handle in either direction.

The latch block 744 may be considered a first locking member of the lock assembly, and the drive hub block 743 may be considered a second locking member of the lock assembly.

In this way, operation of the lock 710 can, via the locking actuator 720, linkage 750, and locking arm 740, prevent rotation of the handle in the releasing direction. This allows the door to be secured (at least to some extent) solely by use of the lock 710.

Moreover, the handle is still free to be moved in the securing direction. This allows a user to operate the lock and the handle in either order to fully secure the door.

States

FIGS. 2 to 12 show different states of the lock assembly. Transitions between these states may be caused by the operation of one or more of the handle, the daylatch handle, and the lock 710.

Using the Handle

FIG. 2 shows a state of the lock assembly in which the latch 310 is in the engaged position, the deadbolt 410 and shootbolt actuators 210, 220 are in their respective disengaged positions, and the daylatch block 622, lock actuator 720, and locking arm 740 are in their respective unlocked positions.

In this state, the handle is free to turn in either direction, and the only securing is by the latch 310. The door could therefore be opened from either side by operation of the handle.

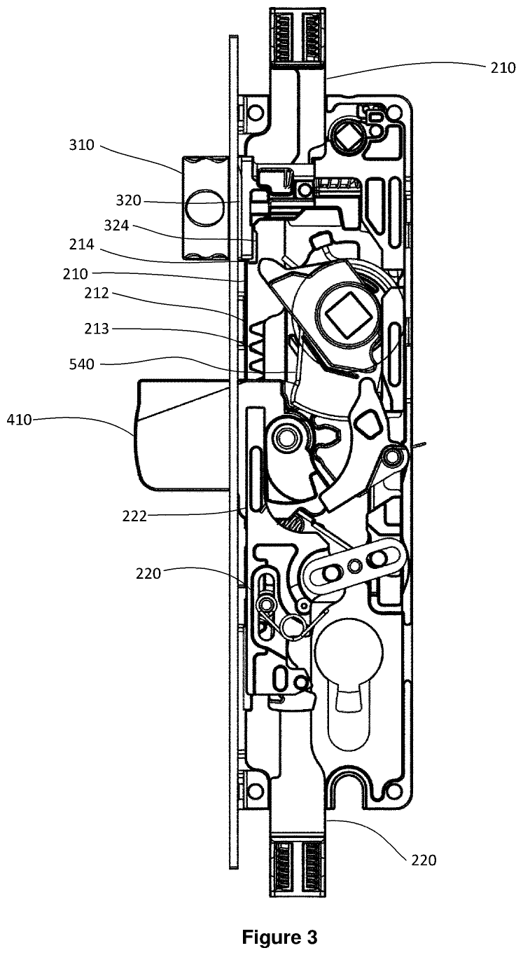

FIG. 3 shows the state of the lock assembly of FIG. 2 while the handle is operated in a securing direction (such as anti-clockwise). The latch 310 remains in the engaged position. Rotation of the handle causes the drive core 530 and drive gear 540 to rotate, which in turn causes the deadbolt 410 to move towards its engaged position. In addition, rotation of the deadbolt 410 causes rotation of the gear 230, which in turn causes the shootbolt actuators 210, 220 to move towards their respective engaged positions. A single use of the handle therefore causes four points of locking to be engaged: the latch 310, the deadbolt 410, and the shootbolts.

In addition, the block 214 of the top shootbolt actuator 210 is moved into alignment with the face 324 of the latch chassis 320. This prevents the latch 310 being pushed inwards other than by use of the handle.

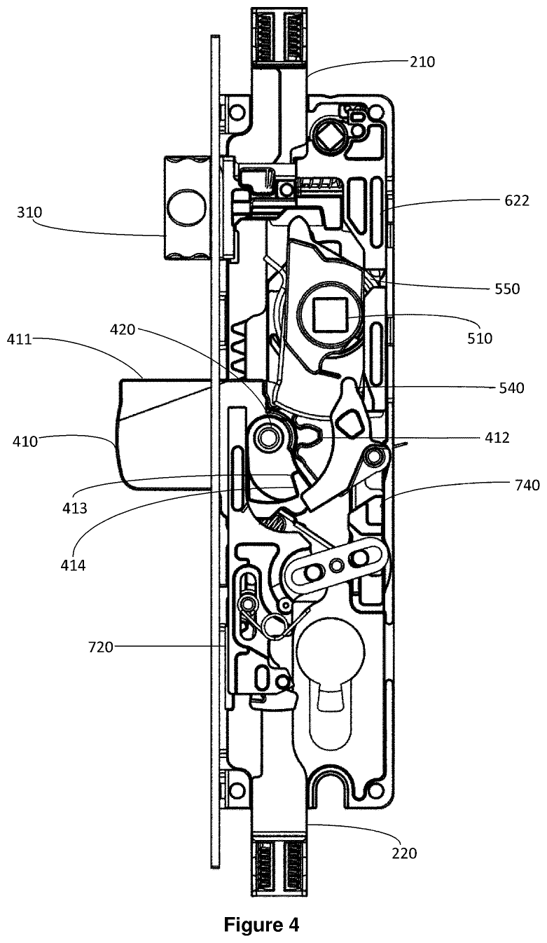

FIG. 4 shows the state of the lock assembly of FIG. 3 after the handle has been fully operated in the securing direction, and then handle has been released. The spring 550 causes the handle and the drive hub 510 to move back to the neutral position. However, due to the lost motion between the drive core 530 and the drive gear 540, the drive gear remains in the same position as in FIG. 3. The latch 310, deadbolt 410, and shootbolt actuators 210, 220 are in their respective engaged positions, and the daylatch block 622, lock actuator 720, and locking arm 740 are in their respective unlocked positions.

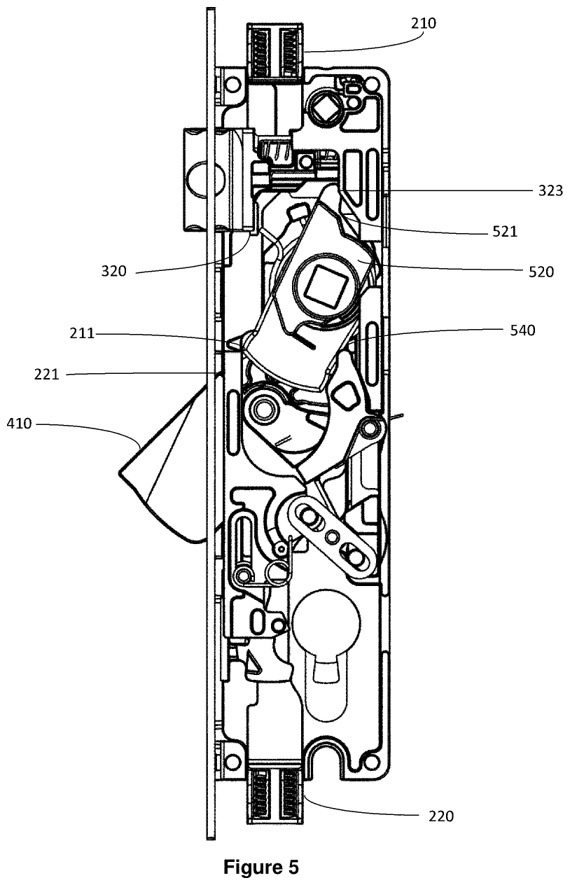

FIG. 5 shows the state of the lock assembly of FIG. 4 while the handle is operated in a releasing direction (such as clockwise). Rotation of the handle causes the drive cam 520, drive core 530, and drive gear 540 to rotate.

The latch 310 is moved towards the disengaged position by operation of the finger 521 of the drive cam 520 on the shoulder 323 of the latch chassis 320.

The deadbolt 410 is moved towards the disengaged position by operation of the teeth 531 of the drive core 530 pushing against bearing surfaces 541 of the drive gear 540. Consequently, the shootbolt actuators 210, 220 are moved towards their disengaged positions by operation of the gear 230 on the racks 212, 222.

After the handle has been fully operated in the releasing direction, and then handle has been released, the lock assembly is in the state of FIG. 2.

Using the Lock

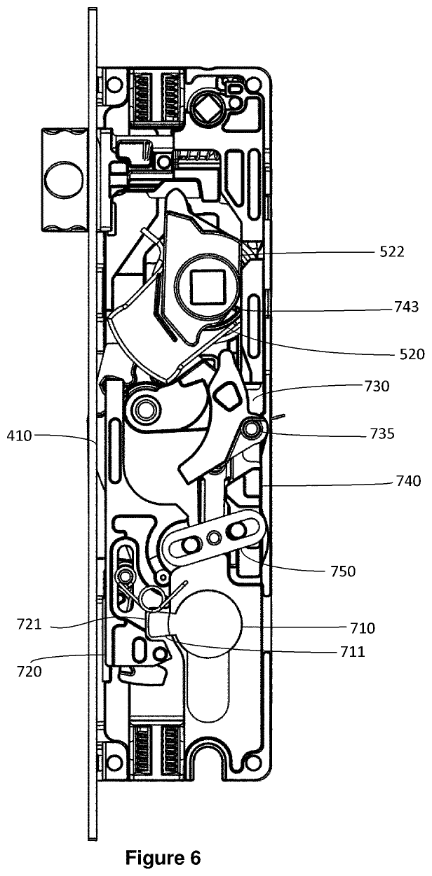

FIG. 6 shows the state of the lock assembly of FIG. 2 while the lock 710 is being operated in a securing direction (such as anti-clockwise). This may occur by a suitable key being inserted into the lock 710 and turned in the securing direction.

The cam 711 of the lock 710 is located in the cam recess 721 of the lock actuator 720. Due to the rotation of the cam 711, the lock actuator 720 is pushed downwards towards its locked position. This causes the locking arm 740 to move towards its locked position due to the linkage 750.

The drive hub block 743 of the locking arm 740 is moved in line with at least part of the edge 522 of the drive cam 520. This prevents the drive cam 520 (and consequently the handle) from being rotated clockwise, but does not impede anti-clockwise rotation.

The locking arm 740 in the locking position is out of alignment with the deadbolt lock 730. However, the deadbolt lock 730 remains in the unlocked position due to the deadbolt 410 abutting the deadbolt lock 730 and resisting spring 735.

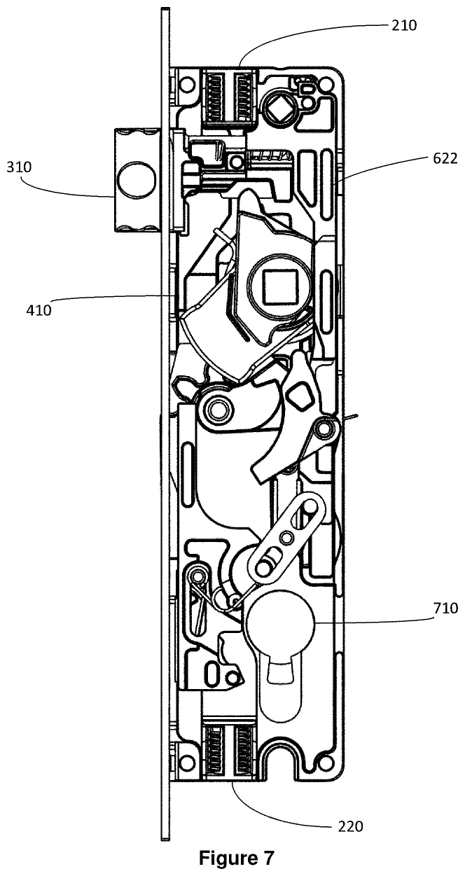

FIG. 7 shows the state of the lock assembly of FIG. 6 after the lock 710 has been fully operated in the securing direction. The key can be removed (if any) from the lock 710. The latch 310 remains in the engaged position, the deadbolt 410 and shootbolt actuators 210, 220 remain in their respective disengaged positions, and the daylatch block 622 remains in its unlocked position.

The lock 710 can therefore be used to lock the handle and latch without engaging further securing points.

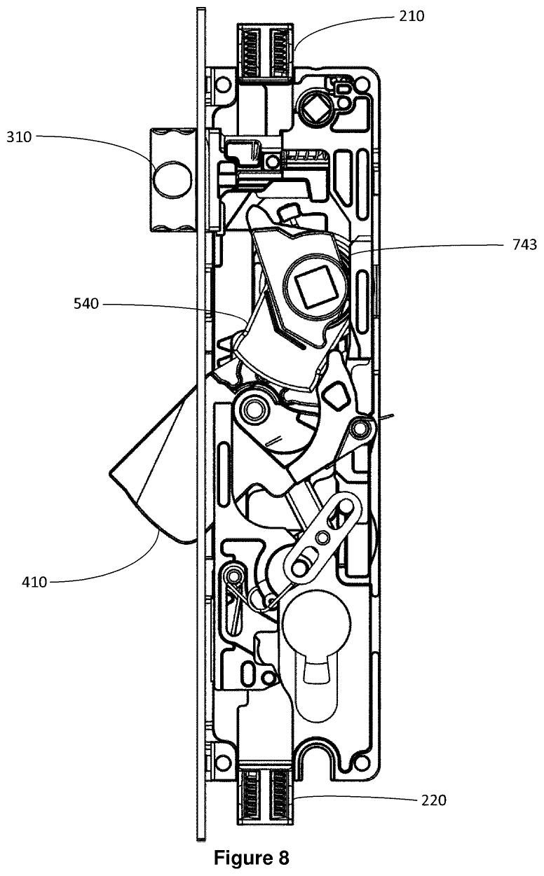

FIG. 8 shows the state of the lock assembly of FIG. 7 while the handle is operated in the securing direction (such as anti-clockwise). The latch 310 remains in the engaged position. Rotation of the handle causes the drive core 530 and drive gear 540 to rotate. Because the drive hub block 743 only impedes rotation in the releasing direction, the drive hub block 743 does not impede this rotation. This causes the deadbolt 410 to move towards its engaged position. In addition, rotation of the dead bolt 410 causes rotation of the gear 230, which in turn causes the shootbolt actuators 210, 220 to move towards their respective engaged positions.

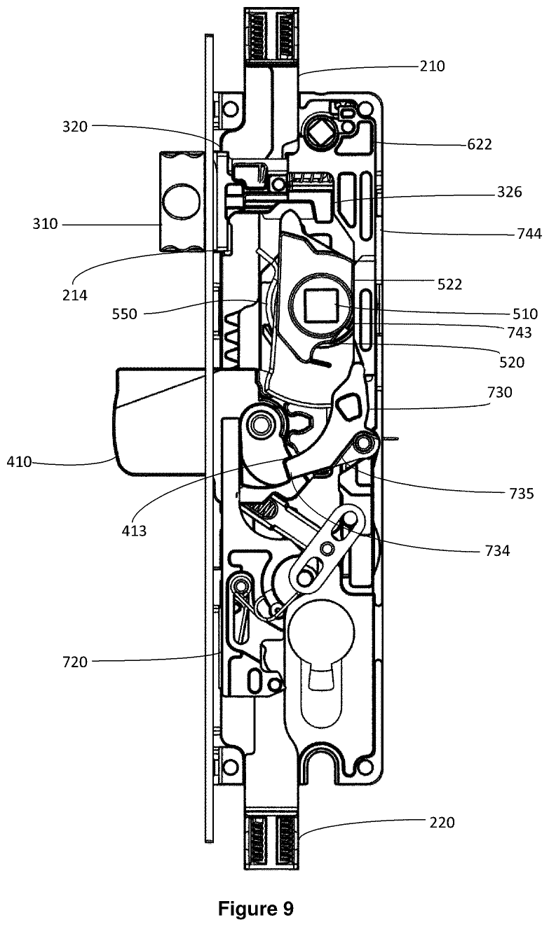

FIG. 9 shows the state of the lock assembly of FIG. 8 after the handle has been operated fully in the securing direction and then released.

The spring 550 causes the handle and the drive hub 510 to move back to the neutral position.

The deadbolt lock 730 has moved into the locked position. This is caused by spring 735 biasing the deadbolt lock 730 towards the locked position, and by the locking arm 740 and the deadbolt 410 no longer resisting the urging of spring 735. The extension 734 of the deadbolt lock 730 is therefore located in the notch 413 of the deadbolt 410. The deadbolt 410 is therefore locked in the engaged position by the deadbolt lock 730.

The drive hub block 743 of the locking arm 740 is aligned with the edge 522 of the drive cam 520. This prevents the drive cam 520 (and consequently the handle) from being rotated clockwise.

The latch block 744 of the locking arm 740 is located in line with the end 326 of the latch chassis 320. This prevents the latch chassis 320 (and consequently the latch 310) from being moved towards their respective disengaged positions.

The block 214 of the top shootbolt actuator 210 is aligned with the latch chassis 320. This prevents the latch 310 being pushed inwards other than by use of the handle.

The spring 550 causes the handle and the drive hub 510 to move back to the neutral position. However, due to the lost motion between the drive core 530 and the drive gear 540, the drive gear remains in the same position as in FIG. 3. The latch 310, deadbolt 410, and shootbolt actuators 210, 220 are in their respective engaged positions, and the daylatch block 622, lock actuator 720, and locking arm 740 are in their respective unlocked positions.

Thus by operating both the handle and the lock 710 in their respective securing directions, the lock assembly secures a door with multiple external points of locking (that is, the latch, the deadbolt, and the shootbolts) and multiple internal points of locking (that is, the drive hub block 743 and latch block 744 of the locking arm 740, the block 214 of the top shootbolt actuator 210, and the deadbolt lock 730). This presents a lock assembly with a high degree of security.

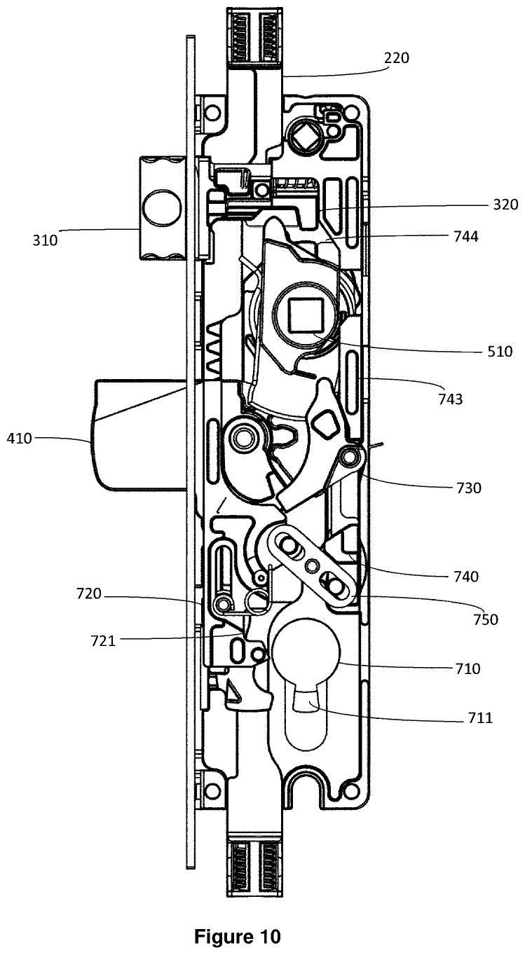

FIG. 10 shows the state of the lock assembly of FIG. 9 after the lock 710 has been operated fully in the releasing direction.

The cam 711 of the lock 710 has pushed upwards in the cam recess 721 of the lock actuator 720 towards its unlocked position. This caused the locking arm 740 to also move into its locked position due to the linkage 750.

Thus the drive hub block 743 no longer impedes the drive hub 510 from rotating in the releasing direction and the latch block 744 no longer impedes the latch chassis 320 from moving towards its disengaged position. In addition, the locking arm pushes against the deadbolt lock 730, causing the deadbolt lock 730 to pivot into the unlocked position.

However, the latch 310, deadbolt 410, and shootbolts remain engaged, until the handle is operated in the releasing direction as shown in FIG. 5 to bring the lock assembly to the state of FIG. 2.

Using the Daylatch

The purpose of a daylatch is to allow a user to lock the latch in place. A user on the outside is then not able to open the door just by actuating the handle. This allows a degree of security without the need to lock the door using the lock.

The daylatch is engaged by operating a daylatch handle in a securing direction, and can be disengaged by rotating the daylatch handle in the opposing, releasing direction. The daylatch handle may be provided only one side of the door.

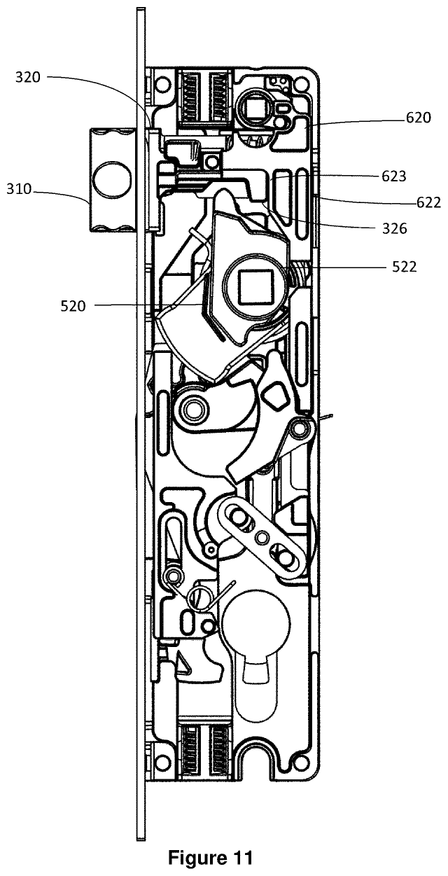

FIG. 11 shows the state of the lock assembly of FIG. 2 after the daylatch is engaged.

The daylatch plate 620 is moved into its locked position. This causes the daylatch block 622 to be aligned with the latch chassis 320. If the latch chassis 320 is attempted to be moved towards its disengaged position, the end 326 of the latch chassis 320 will abut the latch abutment face 623 of the daylatch block 622. This impedes the latch chassis 320 (and thus the latch 310) from moving into their respective disengaged positions.

In addition, the daylatch block 622 is also aligned with the drive cam 520. If the drive cam 520 is attempted to be rotated in a releasing direction (such as by a handle being operated), the edge 522 of the drive cam 520 will abut the drive hub abutment face 624 of the daylatch block 622. This impedes the drive cam 520 and the handle from being used to move the latch 310 towards the disengaged position.

Thus the daylatch provides two independent points of locking on the latch, providing a secure means of locking the latch without using the lock 710.

If the daylatch handle is subsequently moved in a releasing direction, the lock assembly will revert to the state shown in FIG. 2. This provides a simple manner of engaging and disengaging the daylatch.

A daylatch cannot be disengaged from the outside by use of a daylatch handle. This is because a daylatch handle is typically only provided on the inside. However, a user on the outside may disengage the daylatch using the lock 710. In particular, the user locks the lock 710 (that is, fully rotates the cam 711 in the securing direction) to disengage the daylatch. The user can then unlock the lock 710 (that is, fully rotates the cam 711 in the releasing direction) and use the handle to open the door.

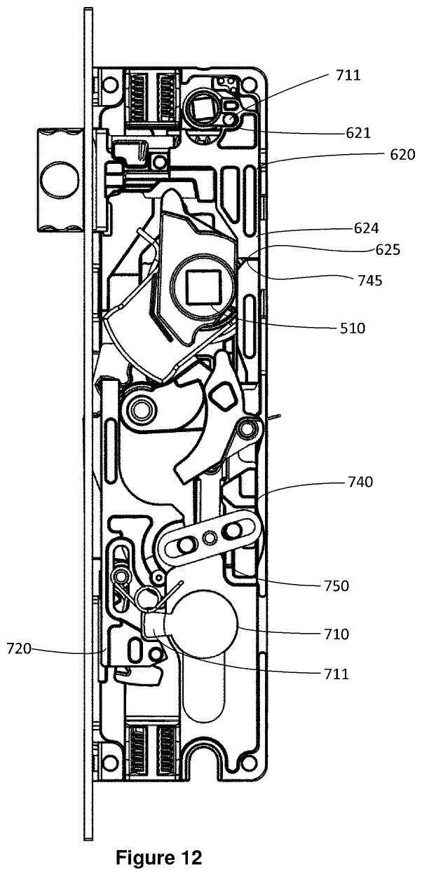

FIG. 12 shows the state of the lock assembly of FIG. 11 while the lock 710 is being operated in the securing direction.

Due to the rotation of the cam 711, the lock actuator 720 is pushed downwards towards its locked position. This causes the locking arm 740 to move towards its locked position due to the linkage 750.

A daylatch abutment face 745 of the locking arm 740 pushes against a locking arm abutment face 625 of the daylatch plate 620. As the locking arm 740 moves towards its locked position, the daylatch plate 620 is forced towards its unlocked position. While this occurs, the drive hub 510 remains impeded from turning in the releasing direction by one or both the drive hub abutment face 624 of the daylatch block 622 and the drive hub block 743 of the locking arm 740. Thus the drive hub 510 is not able to be turned in the releasing direction while the daylatch is being disengaged via use of the lock 710.

After the lock 710 has been fully operated in the securing direction, the daylatch is disengaged. The lock assembly will therefore be as shown in FIG. 7.

In this way, the lock 710 can be used to disengage the daylatch. The lock 710 could then be unlocked in order to permit the door to be opened.

Interpretation

While the present invention has been illustrated by the description of the embodiments thereof, and while the embodiments have been described in detail, this should not be taken to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the general inventive concept.

It is acknowledged that the terms “comprise”, “comprises”, and “comprising” may, under varying jurisdictions, be attributed with either an exclusive or an inclusive meaning. For the purpose of this specification, and unless otherwise noted, these terms are intended to have an inclusive meaning—that is, they will be taken to mean an inclusion of the listed components which the use directly references, and possibly also of other non-specified components or elements.

What is claimed is:

1. A lock assembly, comprising:
a drive hub configured to be rotated in a first angular direction;
a latch having a latch engaged position;
a lock having a locked mode;
a first locking member configured such that, when the lock is in the locked mode, the first locking member retains the latch in the latch engaged position; and
a second locking member configured such that, when the lock is in the locked mode, the second locking member prevents the drive hub from rotating in the first angular direction.

2. The lock assembly of claim 1, wherein the first locking member and the second locking member are part of a locking arm having a lock engaged position.

3. The lock assembly of claim 2, wherein the latch comprises a latch chassis and the first locking member is configured to abut an end of the latch chassis when the locking arm is in the lock engaged position.

4. The lock assembly of claim 1, wherein the drive hub comprises a drive cam which translates rotation of the drive hub to movement of the latch.

5. The lock assembly of claim 4, wherein the second locking member abuts the drive cam when the lock is in the locked mode.

6. The lock assembly of claim 1, wherein the drive hub causes the latch to move from the latch engaged position to a latch disengaged position.

7.-8. (canceled)

9. The lock assembly of claim 1, wherein the lock engages a lock actuator, the lock actuator being linked to a locking arm.

10. The lock assembly of claim 9, wherein moving the lock into the locked mode causes the lock actuator to move the locking arm into a locked position.

11. The lock assembly of claim 9, wherein moving the lock into an unlocked mode causes the lock actuator to move the locking arm into an unlocked position.

12. The lock assembly of claim 1, further comprising a shootbolt actuator, wherein the shootbolt actuator comprises a third locking member configured to prevent the latch moving into a latch disengaged position when the shootbolt actuator is in a shootbolt engaged position.

13. The lock assembly of claim 1, further comprising a deadbolt having an engaged position further comprising a deadbolt lock having a locked position in which the deadbolt lock is configured to retain the deadbolt in the engaged position.

14. (canceled)

15. The lock assembly of claim 13, wherein the deadbolt lock is biased towards the locked position.

16. The lock assembly of claim 13 wherein the deadbolt lock is configured to be moved into an unlocked position when the lock is in an unlocked position.

17.-28. (canceled)

29. A lock assembly, comprising:
a lock having a locked mode and an unlocked mode;
a deadbolt having a disengaged position and an engaged position;
wherein when the lock is in the locked mode, the deadbolt is able to be moved from the disengaged position to the engaged position wherein the deadbolt is configured to be moved between the engaged position and the disengaged position by rotation of a drive hub.

30. The lock assembly of claim 29, wherein when the lock is in the unlocked mode, the deadbolt is able to be moved from the disengaged position to the engaged position.

31. The lock assembly of claim 29, wherein when the lock is in the locked mode, the deadbolt is not able to be moved from the engaged position to the disengaged position.

32. The lock assembly of claim 29, further comprising a deadbolt lock having an engaged position in which the deadbolt is retained in an engaged position.

33. The lock assembly of claim 32, wherein the deadbolt lock is biased into the engaged position.

34. The lock assembly of claim 32, wherein the deadbolt lock is configured to move into a disengaged position when the lock is moved into an unlocked mode.

35.-37. (canceled)

38. A door comprising a lock assembly according to claim 1.
